(19) United States
(12) Patent Application Publication
(10) Pub. No.: US 2015/0317417 A1
(43) Pub. Date: Nov. 5, 2015

(54) METHODS AND SYSTEMS TO CONTROL AN ADAPTIVE TIME-STEP

(71) Applicant: TEXAS INSTRUMENTS INCORPORATED, Dallas, TX (US)

(72) Inventor: Gang Peter FANG, Plano, TX (US)

(21) Appl. No.: 14/268,054

(22) Filed: May 2, 2014

(51) Int. Cl. G06F 17/50

(52) U.S. Cl. CPC G06F 17/5009; G06F 17/5036

(57) ABSTRACT

A method (and system) includes receiving a set of nonlinear algebraic equations for a system at a current time point, calculating a set of solutions to the set of nonlinear algebraic equations by using a first time step, and determining whether a maximum value of a local truncation error associated with a first solution of the set of solutions is greater than a threshold. Based on the maximum value of the local truncation error being greater than the threshold, the method includes iteratively calculating a coupled set of equations to generate a second time step so as to make a maximum value of local truncation error associated with a set of solutions to the coupled set of equations not greater than the threshold, wherein the coupled set of equations comprises the received set of nonlinear algebraic equations and a local truncation error equation corresponding to the first solution, with a time step that is an unknown variable in the coupled set of equations.

### CROSS-REFERENCE TO RELATED APPLICATION

This application claims priority to U.S. Provisional Application 61/819,339 filed May 3, 2013, titled “An Adaptive Time-Step Control Method for Simulation”, and incorporated herein by reference.

### BACKGROUND

An adaptive time-stepping method is widely used in a computer-based simulation of a system. Generally used in a transient analysis of the system, the adaptive time-stepping method refines a size of a time step accordingly so as to cause simulated results to satisfy a predefined condition.

### SUMMARY

Systems and methods to determine a step size in a simulator are disclosed herein. In an embodiment, a method includes: receiving a set of nonlinear algebraic equations for a system at a current time point, and calculating a set of solutions to the set of nonlinear algebraic equations by using a first time step, wherein each of the solutions corresponds to a node of the system and a time step is an interval between a previous time point and the current time point. Further, the method includes determining whether a maximum value of a local truncation error associated with a first solution of the set of solutions is greater than a threshold. Based on the maximum value of the local truncation error being greater than the threshold, the method includes iteratively calculating a coupled set of equations to generate a second time step so as to make a maximum value of local truncation error associated with a set of solutions to the coupled set of equations not greater than the threshold, wherein the coupled set of equations comprises the received set of nonlinear algebraic equations and a local truncation error equation corresponding to the first solution, with a time step that is an unknown variable in the coupled set of equations.

In another embodiment, a system includes an input device, a processor, and a storage device coupled to the processor. The input device is configured to receive a set of nonlinear differential algebraic equations that describes the system, and a set of control parameters, such as start time and stop time for a transient simulation. The storage device is configured to store a plurality of software instructions. While the software instructions being executed by the processor, the software instructions cause the processor to calculate a set of solutions to the set of nonlinear algebraic equations by using a value for a first time step, wherein each of the solutions corresponds to a node of the system and a time step is an interval between a previous time point and the current time point, determine whether a maximum value of local truncation error associated with a first solution of the set of solutions is greater than a threshold. Further, based on the maximum value of the local truncation error being greater than the threshold, the software instructions cause the processor to iteratively calculate a coupled set of equations to generate a second time step so as to make a maximum value of local truncation error associated with a set of solutions to the coupled set of equations not greater than the threshold, wherein the coupled set of equations comprises the received set of nonlinear algebraic equations and a local truncation error equation corresponding to the first solution, with a time step that is an unknown variable in the coupled set of equations.

In a further embodiment, a non-transitory, computer-readable storage device containing instructions that, when executed by a processor, cause the processor to calculate a set of solutions to the set of nonlinear algebraic equations by using a value for a first time step, wherein each of the solutions corresponds to a node of the system and a time step is an interval between a previous time point and the current time point, determine whether maximum value of local truncation error associated with a first solution of the set of solutions is greater than a threshold, and based on the maximum value of the local truncation error being greater than the threshold, iteratively calculate a coupled set of equations to generate a second time step so as to make a maximum value of local truncation error associated with a set of solutions to the coupled set of equations not greater than the threshold, wherein the coupled set of equations comprises the received set of nonlinear algebraic equations and a local truncation error equation corresponding to the first solution, with a time step that is an unknown variable in the coupled set of equations.

### BRIEF DESCRIPTION OF THE DRAWINGS

For a detailed description of exemplary embodiments of the invention, reference will now be made to the accompanying drawings in which:

FIG. 1 shows a system to implement an adaptive step-size for a simulation in accordance with various embodiments;

FIG. 2 shows an example of a storage device that includes an adaptive step-size generation module in accordance with various embodiments;

FIG. 3 shows a method to implement an adaptive step-size for a simulation in accordance with various embodiments; and

FIG. 4 shows a method to further illustrate an implementation of an adaptive step-size for a simulation in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct connection. Thus, if a first device couples to a second device, that connection may be through a direct connection, or through an indirect connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Computer-based simulation enables the analysis of complex systems before time and expense of actually implementing the systems is incurred. Generally, a simulator is a system or an engine executing a software application that analyzes a system (e.g., a circuit design) based on a description of that system to predict behaviors of the system under a given set of conditions. Thus, the simulator is not just software. Typically, the system description is made up of equations describing the desired behavior of the system. The simulator solves these equations in the context of simulated conditions represented by stimuli applied to the system so that the system is operated under the simulated conditions.

In one example, a circuit simulator is frequently used to simulate a circuit design. The circuit simulator constructs circuit equations from mathematical models of components in a circuit. The mathematical models may be provided in the circuit simulator (e.g., semiconductor device models of SPICE-like simulators), and/or may be specified by a user using a hardware description language (e.g., Verilog-A). The circuit simulator combines the mathematical models of the components with equations that describe the interconnections of the components to construct a set of nonlinear differential algebraic equations (DAEs) that describe the circuit. In many circuit simulators, the interconnection equations are derived from Kirchoff's voltage and current laws which require that the sum of all currents flowing out of a node at any instant is zero and the algebraic sum of all branch voltages around a loop at any instant in time is zero. The node in a circuit design is a physical point of the circuit design; the loop is made up of at least two nodes in the circuit design, wherein the loop includes the same starting node and ending node.

A variety of types of analyses of a circuit design may be implemented by using the circuit simulator, for example, transient analysis, direct current (DC) analysis, alternative current (AC) analysis, Monte Carlo analysis, etc. For the transient analysis, the circuit simulator computes the response of a circuit as a function of time. To perform the transient analysis, the differential algebraic equations (DAEs) describing the circuit are discretized in time to convert the solution of equations into a problem of solving a sequence of systems of nonlinear algebraic equations (NAEs). In other words, the differential equations are numerically integrated to replace the time derivative operator with a discrete-time approximation and the resulting finite difference equations are solved one time point at a time starting from an initial condition.

More particularly, the transient analysis determines the time domain response of the circuit design over a time interval [0, T]. The transient solution to the system of differential equations is computed by dividing this time interval into discrete time points [0, t1, t2, . . . , T], and applying a numerical integration method at each time point to transform the differential equations into equivalent algebraic equations. The circuit simulator solves these nonlinear algebraic equations (NAEs) on every time point of a transient analysis. The solution to the NAEs is obtained by executing an iterative sequence of linearized solutions.

The Newton-Raphson method, also called the “Newton method” or “Newton iteration,” is a commonly used linearization method. The Newton-Raphson method begins with an initial guess for the solutions to the NAEs. The NAEs are then linearized around that guess, and the resulting linear system is solved. One common technique used to solve such a linear system in circuit simulators is Lower Upper (LU) factorization. LU factorization is a modified version of Gaussian elimination. The linear equations of the linear system are presented as a circuit matrix, i.e., a modified nodal analysis (MNA) circuit matrix which is typically a Jacobian matrix, and the matrix is factorized into a product of lower- and upper-triangular matrices. Subsequently, forward and backward substitutions are performed to obtain the solution. Once the solution is obtained, the NAEs are then re-linearized around the solution and the procedure repeats until the process converges.

As mentioned above, numerical integrations with the discrete-time approximation are used to replace the time derivative operators in the DAEs. Several numerical integration methods are frequently used, including but not limited to, the trapezoid rule, backward Euler, and backward difference formulas. Regardless of which method is used, a time step is needed to discretize the time interval [0, T] into distinct time points [0, t1, t2, . . . , T]. The time points may be equally spaced, which means that there is only one fixed value, or size, for the time step. However, modern analog and mixed signal circuits are typically “stiff” systems characterized by a wide range of time constants. Thus, in a transient analysis, it may be desirable to dynamically vary the size of time step. For example, taking small time steps when the circuit performs in a state of fast transition may advantageously preserve accuracy; on the other hand, taking large time steps may be advantageous in terms of time when the circuit is performing in a state with less activity. As such, an adaptive time-stepping process may be desirable in order to enhance the efficiency of the circuit simulator. The adaptive time-stepping may be a method to be implemented in the circuit simulator to thereby dynamically vary the size of time step so as to satisfy conditions of stability and local truncation error (LTE). Hereinafter, the size of time step is referred to as a “step size” for clarity purposes.

Generally, the LTE is associated with using the discrete-time approximation to solve the NAEs. The LTE of a numerical method is an estimate of the error introduced in a single iteration of the method, assuming that all inputs and data provided to the method are accurate. Details of the implementation of LTE in are discussed below.

Although a variety types of adaptive time-stepping method or algorithm have been proposed and implemented in the circuit simulator over many years, such methods are implemented to predict a step size for a current time point based on prior information, such as step sizes and local truncation errors from previous time point(s) and based on a violation of satisfying a LTE condition, to refine (i.e., decrease) the step size until no violation is present. In some examples, especially in a stiff circuit, these methods may become inefficient since the stiff circuit may be characterized with strong nonlinearity, causing a dramatic change of the DAEs from time point to time point. Moreover, conventional methods are derived based on solving an initial condition problem, that is, no external stimulus present. In reality, some circuits are driven by one or more time-varying independent sources for transient simulation. Thus, a system and/or a method capable of determining the step size, instead of being based on a random guess, for solving the DAEs may advantageously enhance the efficiency of the circuit simulator.

Based on a violation of a predefined LTE condition (i.e., solved solutions using an initial step size including an inacceptable LTE), embodiments of the disclosed invention provide systems and methods to determine the step size in the transient analysis of a circuit design by solving a coupled NAEs and LTE equations. As such, the step size may be more efficiently and precisely determined so that the disclosed systems and methods may advantageously provide a more efficient way to simulate the circuit design. More particularly, the disclosed system and method may be generalized to analyze the transient response of a system in any suitable scientific and engineering applications that can be described by analogous DAEs.

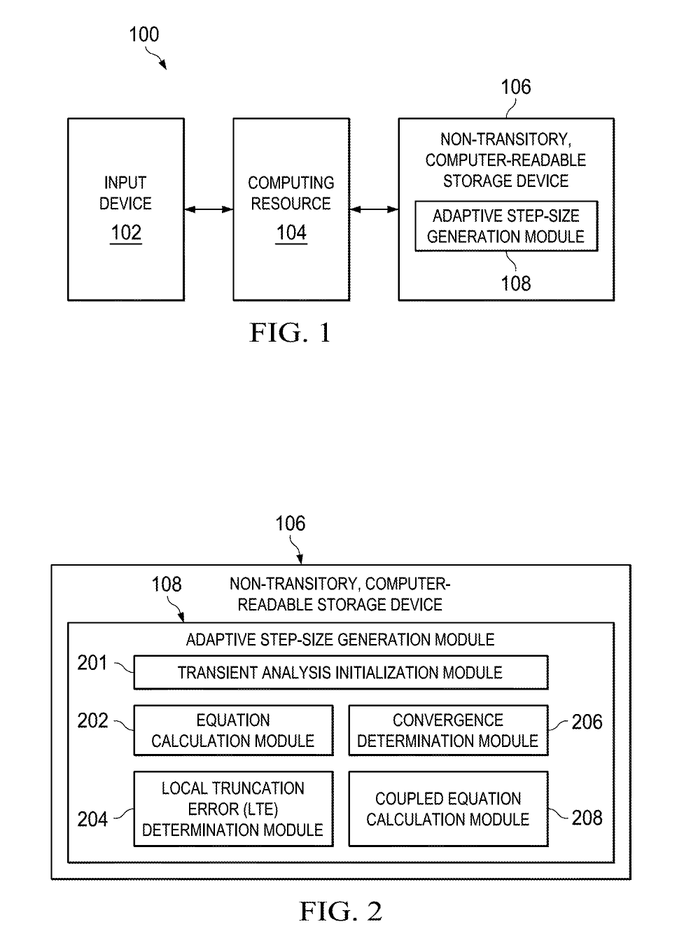

FIG. 1 shows a system 100 to adaptively determine and generate a step size for a transient analysis of a circuit design in accordance with various embodiments. The system 100 includes an input device 102, a computing resource 104, and a non-transitory, computer-readable storage device 106. The computing resource 104 couples to both the input device 102 and the storage device 106. The non-transitory, computer-readable storage device 106 further includes an adaptive step size generation module 108 which is executable by the computing resource 104.

In FIG. 1, the input device 102 is configured to receive a set of DAEs for the circuit design. In a preferred embodiment, the computing resource 104 may execute the adaptive step size generation module 108 to process the received DAEs so that the behaviors of the circuit design are analyzed. More particularly, the set of DAEs is based on Kirchhoff's laws and can be generalized as equation (1).

$$\overline{fckt} ( \overline{v} ( t ) ) = \frac{d \overline{q} ( \overline{v} ( t ) )}{d t} + \overline{i} ( \overline{v} ( t ) ) + \overline{u} ( t ) = 0 \qquad ( 1 )$$

where ūεR^{N} is the vector of input sources, v̅εR^{N} is the vector of solution variables, and l̅, q̅εR^{N} are the vector of resistive currents and node charges/branch fluxes. A node is a point of physical connection between nets of continuous-time description, and a branch is a path between two nodes. R^{N} is a real N-dimensional vector space and an element of R^{N} can be expressed as v̅=(v₁, v₂, . . . , v_{N}). An input source (also called an input signal) may be an input voltage or current stimulus signal. A solution variable is a circuit signal, e.g., a voltage or a current, which represents an unknown in the circuit equations. Details of the adaptive step size generation module 108 will be discussed with respect to FIG. 2.

Still referring to FIG. 1, in accordance with various embodiments, the computing resource 104 may include one or more processors, wherein each of the processors may include a single-core central processing unit (CPU) or a multi-core CPU. Additionally or alternatively, the computing resource 104 may be implemented as a computer or a computer cluster.

FIG. 2 shows a block diagram to further illustrate the non-transitory, computer-readable storage device 106 in accordance with various embodiments. The storage device 106 includes a variety of modules that can be executed by the computing resource 104 to perform any or all of the functionality described herein.

As shown in the example of FIG. 2, the adaptive step size generation module 108 includes five modules which may include a transient analysis initialization module 201, an equation calculation module 202, a local truncation error (LTE) determination module 204, a convergence determination module 206, and a coupled equation calculation module 208. Each module of FIG. 2 may be executed by the computing resource 104 to implement the functionality described herein. The functions to be implemented by executing the modules 202, 204, 206, and 208 will be described with reference to the flow diagram of FIG. 4. The combination of the computing resource 104 executing a particular module represents an “engine.” Thus, the computing resource executing the various modules implements a transient analysis initialization engine, an equation calculation engine, an LTE engine, a convergence determination engine, and a coupled equation calculation engine.

As mentioned above, the LTE occurs when the derivative operator in the DAEs is replaced with the discrete-time approximation. More particularly, the LTE is the error incurred in a single step (e.g., time step) assuming all previous steps are accurate. Modern circuit simulators calculate a difference between a computed solution and a polynomial extrapolation from previous time steps. A maximum difference εₘ is estimated and expressed as in equation (2),

εₘ=|vᵢ(tₘ)−v_{i,extrapolated}| (2)

where i is an index of solution variables with the maximum difference. Generally, in some preferred embodiments, the solution variable is a node voltage. The corresponding node (i.e., the node with the maximum difference) may be referred to as a controlling LTE node. More particularly, the controlling LTE node may vary from time point to time point. For example, a controlling LTE node at a first time point may be different from a controlling LTE node at a second time point. Still in some preferred embodiments, equation (3) below provides an LTE condition to determine whether a step size is acceptable:

εₘ<γ·τₘ (3)

where τₘ is the tolerance for the LTE and γ is a coefficient greater than 1. Details of various implementations of the LTE condition in the adaptive step size generation module 108 will be explained with respect to the flow chart in FIG. 4.

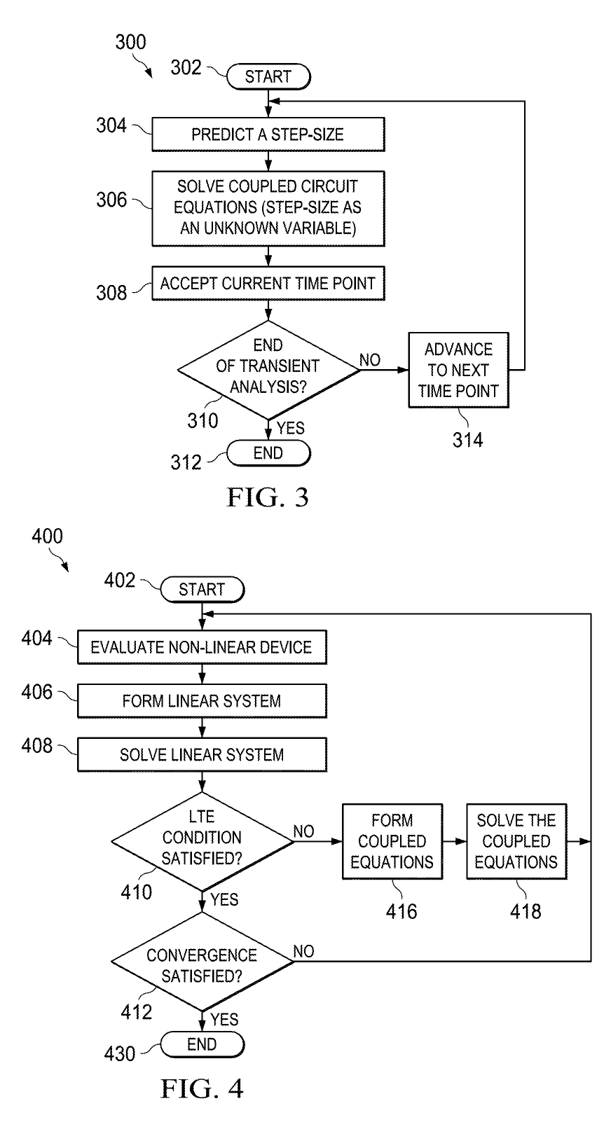

FIG. 3 shows a flow diagram 300 to illustrate a top-level method to implement the disclosed adaptive stepping to analyze the transient response of the circuit in accordance with various embodiments. The flow diagram 300 starts with block 302, wherein the block 302 may include receiving one set of DAEs that describes the circuit at a current time point (e.g., t=0, t₁, etc.) within the time interval [0, T]. To begin solving the DAEs, the flow diagram 300 continues with block 304 to predict an initial step size. In a preferred embodiment, the initial prediction of the step size may be randomly chosen or determined by a user who intends to simulate the circuit. Different from conventional adaptive time-stepping methods which uses the initial prediction to refine the step size in order to satisfy the LTE condition, the disclosed embodiment, at block 306, incorporates the LTE condition as an additional equation into the DAEs. In other words, the step size, in the current embodiment, is treated as an unknown variable to be solved. As such, at block 306, a coupled circuit equations will be solved to generate a value for the time step (i.e., step size) and concurrently the solutions for the DAEs will be solved as well. Once the solution and the step size have been obtained at block 306, the flow diagram 300 continues at block 308 to determine whether the solved solutions are accepted. By “accepted”, in a preferred embodiment, it is meant that the solutions are within a tolerance which may be pre-determined by the user.

Still referring to FIG. 3, at block 308, if the solutions at current time point are accepted, the flow diagram 300 routes to block 310 to determine whether an end of the transient analysis has been reached, which means that the current time point is the end of the interval (i.e., t=T). If the end has been reached, the flow diagram 300 routes to block 312 to end the transient analysis. On the other hand, if the current time point is not the end of the interval, the flow diagram 300 routes to block 314 to advance to a next time point, and the flow diagram 300 iterates to block to block 304 to solve the coupled circuit equations at the next time point.

FIG. 4 shows a flow diagram 400 to further explain the implementation of the adaptive step-size generation module 108 to perform the transient analysis in accordance with various embodiments. The flow diagram 400 starts with block 402, by executing the transient analysis initialization module 201, to start the transient analysis of the circuit at a current time point (tₘ). In a preferred embodiment, the block 402 may include receiving a set of DAEs based on equation (1) for the current time point and transforming the DAEs into NAEs by replacing the derivative operators in the DAEs with discrete-time approximation.

Still referring to block 402, more specifically, to perform the transient analysis, the time derivate term of the DAEs is discretized using a time integration scheme such as the trapezoidal rule, backward Euler, or backward difference formulas (i.e., Gera's methods). For illustration purposes, discretization using backward Euler is described. In a preferred embodiment, the backward Euler time integration scheme is:

$$\frac{d \overline{q} ( \overline{{v}_{m}} )}{d t} \approx \frac{\overline{q} ( \overline{{v}_{m}} ) - \overline{q} ( \overline{{v}_{m - 1}} )}{{h}_{m}} \qquad ( 4 )$$

where m is the time index, hₘ is a time step at time point of time index m (tₘ), is used to discretize the time derivative term of the DAEs, vₘ and vₘ₋₁ are node voltages at the time point tₘ and tₘ₋₁ respectively. The resulting NAEs at the time index m may be expressed as equation (5),

$$\overline{fckt} ( {\overline{v}}_{m} ) = \frac{\overline{q} ( \overline{{v}_{m}} ) - \overline{q} ( \overline{{v}_{m - 1}} )}{{h}_{m}} + \overline{i} ( {\overline{v}}_{m} ) + {\overline{u}}_{m} = 0 \qquad ( 5 )$$

As a result of executing the equation calculation module 202 by the computing resource 104, the flow diagram 400 first routes to block 404 to evaluate the nonlinear devices in the circuit. After evaluating the nonlinear devices in the circuit, the flow diagram routes to block 406 to form a linear system of equations from the NAEs. Subsequently, the flow diagram 400 continues at block 408 to solve the formed linear system of equations to generate the vector of solution variables, v̅ₘ at time point tₘ using a fixed step size hₘ. After the vector of solution variables has been computed, the flow diagram 400 routes to block 410 by executing the local truncation error (LTE) determination module 204. In a preferred embodiment, as described below, blocks 404 to 408 are part of the Newton iteration calculation. As such, there may be a variety of iterative calculations from blocks 404 to 408. Thus, in general, each iteration starts with a solution v̅ₘ̅^̅{̅k̅}̅computed in the previous iteration based on a time step hₘ^{k} wherein k is an index of iteration. More specifically, the time step hₘ^{k} is kept the same for each iteration unless there is an updated value of the step size obtained by solving the N+1 coupled equations, which will be described with respect to blocks 416 and 418.

In some preferred embodiments, at block 104, the nonlinear devices in the circuit are evaluated based on the current solution v̅ₘ̅^̅{̅k̅}̅ and any necessary updates to the NAEs are made based on the evaluations at block 404. Currents, charges, conductances, capacitances, etc. of each device or component in the circuit are expressed as functions of the vector of solution variable v̅ in the NAEs and may need to be changed to reflect the current solution v̅ₘ̅^̅{̅k̅}̅.

At block 410, the solutions in the vector v̅ₘ are detected by the computing resource 104 to search for the LTE controlling node (with maximum difference). Once the LTE controlling node is determined, the computing resource 104 determines whether the LTE condition (equation (3)) is satisfied for the LTE controlling node. If the condition is satisfied, the step size hₘ^{k} currently being used is accepted by the computing resource 104. Subsequently, via executing the convergence determination module 206 by the computing resource 104, the flow diagram 400 routes to block 412 to determine whether a further convergence condition for the LTE equation (3) is satisfied. Based on the convergence condition being satisfied at block 412, the flow diagram 400 routes to block 430 meaning that the calculated vector v̅ₘ is acceptable and final. In a preferred embodiment, the computing resource 104 may advance to solve a vector of solution variable at a next time point, tₘ₊₁. On the other hand, if the convergence is not satisfied at block 412, the flow diagram 400 may iterate back to block 404, 406, and 408 via executing the equation calculation module 202 to generate an updated vector of solution variable v̅ₘ at the time point tₘ.

Referring back to block 410, if the LTE condition is not satisfied for the LTE controlling node, as a result of executing the coupled equation calculation module 208, the flow diagram 400 routes to block 416 to form a coupled set of equations, wherein the coupled equations includes the formed NAEs as of equation (5) and a generalized equation associate with the LTE condition (equation (3)) for the LTE controlling node. More specifically, the generalized equation associate with the LTE condition may be expressed as, fₗₜₑ( v̅ₘ̅,hₘ)=εₘ( v̅ₘ̅,hₘ)−τₘ=0. As such, the coupled equation may be expressed as, F̅_̅{̅c̅o̅u̅p̅l̅e̅d̅}̅( v̅ₘ̅,hₘ)=0, wherein F̅_̅{̅c̅o̅u̅p̅l̅e̅d̅}̅εR^{N+1}, that is, the coupled equations includes N−1 equations and N+1 unknown variables. In other words, step size hₘ now is treated as one of the N−1 unknown variables to be solved. Once the N−1 equations being formed at block 416, the flow diagram 400 routes to block 418 via executing the coupled equation calculation module 208 to solve the coupled equations with N−1 unknown variables. After solving the coupled equations at block 418, an updated value for the step size hₘ may be obtained. By using the updated step size hₘ, the flow diagram 400 iterates back to block 404 to solve the NAEs with N unknown variables and N equations.

In a preferred embodiment, blocks 404, 406, and 408 may result from executing the equation calculation module 202. More particularly, from block 404 to block 408, the Newton-Raphson approach is used to solve the NAEs at the time point tₘ. Essentially, the approach attempts to converge on the solution v̅ₘ at the time point tₘ.

More particularly at block 410, the LTE condition check may include two criteria for the LTE equation. The first criterion is to set an upper and a lower bounds for the LTE, which may be expressed as,

γₘᵢₙτₘ≦εₘ^{k}(vₘ^{k},hₘ^{k})≦γₘₐₓτₘᵢₙ (6)

where γₘₐₓ is a coefficient greater than 1, and γₘᵢₙ is a coefficient between 0 and 1. By setting the lower bound, the step size may be prevented to be unnecessarily small. In a preferred embodiment, the coefficient γₘₐₓ and γₘᵢₙ may be predetermined by the user to precisely control the LTE at each step. The second criterion is to assure that a change of the step size between two iterations is small enough, which may be expressed as,

|Δhₘ^{k+1}|≦η·hₘ^{k} (7)

where η is a relative tolerance for the step size.

The above discussion is meant to be illustrative of the principles and various embodiments of the present invention. Numerous variations and modifications will become apparent to those skilled in the art once the above disclosure is fully appreciated.

It is intended that the following claims be interpreted to embrace all such variations and modifications.

What is claimed is:

1. A method, comprising:
receiving a set of nonlinear algebraic equations for a system at a current time point;
calculating a set of solutions to the set of nonlinear algebraic equations by using a first time step, wherein each of the solutions corresponds to a node of the system and a time step is an interval between a previous time point and the current time point;
determining whether a maximum value of a local truncation error associated with a first solution of the set of solutions is greater than a threshold; and
based on the maximum value of the local truncation error being greater than the threshold, iteratively calculating a coupled set of equations to generate a second time step so as to make a maximum value of local truncation error associated with a set of solutions to the coupled set of equations not greater than the threshold, wherein the coupled set of equations comprises the received set of nonlinear algebraic equations and a local truncation error equation corresponding to the first solution, with a time step that is an unknown variable in the coupled set of equations.

2. The method of claim 1 further comprising determining the maximum value of the local truncation error by searching a set of local truncation errors, each local truncation error corresponding to each of the calculated solutions.

3. The method of claim 1 further comprising, based on the maximum value of the local truncation error not being greater than the threshold, accepting the first time step and additionally determining whether a converge condition is satisfied for the calculated set of solutions based on the first time step.

4. The method of claim 1 further comprising deriving the set of nonlinear algebraic equations for the system is derived from a set of nonlinear differential algebraic equations that describes the system.

5. The method of claim 1 wherein the system is a circuit.

6. The method of claim 1 further comprising calculating the local truncation error by using the local truncation error equation, the local truncation error equation comprises finding a value of difference, for a node, between each of the calculated set of solutions at the current time point and a calculated solution, by using polynomial extrapolation, from a previous time point.

7. The method of claim 1 wherein iteratively calculating the coupled set of equations generates, at each iteration, a new value for the first time step that is used to calculate a set of solutions to the set of nonlinear algebraic equations.

8. A system, comprising:
an input device configured to receive a set of nonlinear differential algebraic equations that describes the system, and a set of control parameters;
a computing resource; and
a storage device coupled to the computing resource, wherein the storage device is configured to store a plurality of software instructions, wherein when executed, the software instructions cause the computing resource to:
calculate a set of solutions to the set of nonlinear algebraic equations by using a value for a first time step, wherein each of the solutions corresponds to a node of the system and a time step is an interval between a previous time point and a current time point;
determine whether a maximum value of local truncation error associated with a first solution of the set of solutions is greater than a threshold; and
based on the maximum value of the local truncation error being greater than the threshold, iteratively calculate a coupled set of equations to generate a second time step so as to make a maximum value of local truncation error associated with a set of solutions to the coupled set of equations not greater than the threshold, wherein the coupled set of equations comprises the received set of nonlinear algebraic equations and a local truncation error equation corresponding to the first solution, with a time step that is an unknown variable in the coupled set of equations.

9. The system of claim 8 wherein the software instructions, when executed, cause the computing resource to determine the maximum value of local truncation error by searching a set of local truncation errors, each local truncation error corresponding to each of the calculated solutions.

10. The system of claim 8 based on the maximum value of local truncation error not being greater than the threshold, the software instructions, when executed, cause the computing resource to:
accept the first time step and additionally determine whether a converge condition is satisfied for the calculated set of solutions based on the first time step.

11. The system of claim 8 the system is a circuit.

12. The system of claim 8 wherein the software instructions, when executed, cause the computing resource to calculate the local truncation error by using the local truncation error equation, the local truncation error equation comprises finding a value of difference, for a node, between each of the calculated set of solutions at the current time point and a calculated solution, by using polynomial extrapolation, from a previous time point.

13. The system of claim 8 wherein the software instructions, when executed, cause the computing resource to iteratively calculate the coupled set of equations to generate, at each iteration, a new value for the first time step that is used to calculate a set of solutions to the set of nonlinear algebraic equations.

14. A non-transitory, computer-readable storage device containing instructions that, when executed by a computing resource, cause the computing resource to:
calculate a set of solutions to the set of nonlinear algebraic equations by using a value for a first time step, wherein each of the solutions corresponds to a node of the system and a time step is an interval between a previous time point and the current time point;
determine whether maximum value of local truncation error associated with a first solution of the set of solutions is greater than a threshold; and
based on the maximum value of the local truncation error being greater than the threshold, iteratively calculate a coupled set of equations to generate a second time step so as to make a maximum value of local truncation error associated with a set of solutions to the coupled set of equations not greater than the threshold, wherein the coupled set of equations comprises the received set of nonlinear algebraic equations and a local truncation error equation corresponding to the first solution, with a time step that is an unknown variable in the coupled set of equations.

15. The non-transitory, computer-readable storage device of claim 14 wherein the instructions, when executed, cause the computing resource to determine the maximum value of local truncation error by searching a set of local truncation errors, each local truncation error corresponding to each of the calculated solutions.

16. The non-transitory, computer-readable storage device of claim 14 wherein the system is a circuit.

17. The non-transitory, computer-readable storage device of claim 14 wherein based on the maximum value of local truncation error not being greater than the threshold, the software instructions, when executed, cause the computing resource to:
accept the first time step and additionally determine whether a converge condition is satisfied for the calculated set of solutions based on the first time step.

18. The non-transitory, computer-readable storage device of claim 14 wherein the instructions, when executed, cause the computing resource to calculate the local truncation error by using the local truncation error equation, the local truncation error equation comprises finding a value of difference, for a node, between each of the calculated set of solutions at the current time point and a calculated solution, by using polynomial extrapolation, from a previous time point.

19. The non-transitory, computer-readable storage device of claim 14 wherein the instructions, when executed, cause the computing resource to iteratively calculate the coupled set of equations to generate, at each iteration, a new value for the first time step that is used to calculate a set of solutions to the set of nonlinear algebraic equations.
